(19) United States
(12) Patent Application Publication
(10) Pub. No.: US 2009/0204433 A1
(43) Pub. Date: Aug. 13, 2009

(54) Method for writing medical prescriptions, storing, and accessing patient medical records with improved portability and improved patient data security using a USB dongle device

(76) Inventors: Garo B. Darian, Pasadena, CA (US); Shane Armani, Porter Ranch, CA (US)

Correspondence Address: Garo B. Darian, Suite 101, 2595 E. Washington Blvd., Pasadena, CA, 91107, US

(21) Appl. No.: 12/069,831

(22) Filed: Feb. 11, 2008

(51) Int. Cl. G06Q 50/00; H04Q 7/20

(52) U.S. Cl. 705/3; 705/2; 455/466

(57) ABSTRACT

A method for writing medical prescriptions, answering prescription refill requests, and managing patient medical records using a portable USB dongle device that contains patient records and software for writing prescriptions, answering prescription refill requests, and accessing and updating the patient records all in a secure manner. The portable USB dongle device connects to a local terminal. The local terminal connects to a server. The server controls access to and improves security for the portable USB dongle device. The portable USB dongle device containing the patient records and software is easily removed and transported to other local terminals.

### CROSS REFERENCE TO RELATED APPLICATIONS

Not Applicable

### FEDERALLY SPONSORED RESEARCH

Not Applicable

### SEQUENCE LISTING

Not Applicable

### BACKGROUND

1. Field of the Invention

The present invention relates generally to medical record storage and prescriptions, and more particularly, to a method for electronically accessing patient history and electronically writing prescriptions.

2. Prior Art

Doctors or their staffs spend a great amount of time writing prescriptions, including time spent: 1) looking up and managing patient records, 2) updating patient records, 3) looking up the phone and/or fax number of a pharmacy, 4) faxing prescriptions to the correct pharmacy, 5) answering refill requests from pharmacies, including updating expired prescriptions, 6) answering requests from pharmacies to use a less expensive generic drug as requested by the insurance carrier. These requests are known as formulary requests. In addition a doctor usually needs to access the patient's history when writing a prescription for the following reasons: 1) The patient may have had an allergic reaction to a particular drug or have had a sensitivity to the dose of a drug in the past. 2) A particular drug or dose of a drug may have been ineffective in the past. 3) The patient may already be taking medication that is known to react with the newly prescribed medication. 4) Changes in a test measurement made over time can help determine the effectiveness of a drug. For example the cholesterol level of blood may be measured over time to determine the effectiveness of a cholesterol medicine. Blood sugar level may be measured over time to determine the effectiveness of a diabetes medicine. 5) A patient's changing condition over time may require dose adjustments.

In addition to helping the doctor write a prescription, there can be other reasons that patient records may be need to be readily available: 1) as defense evidence in the case of a malpractice lawsuit, 2) as an aid in answering questions by insurance companies as part of the process of reimbursing the doctor, 3) as part of an (Drug Enforcement Administration) DEA or other law enforcement investigation.

Since the doctor cannot accurately remember patient history for a large number of patients, a means of storing and cataloging the patent information is needed. The means of storing the patient information should be secure so that doctor patient confidentiality is maintained.

In addition doctors may not always be at their office and need quick access to their patient records, for example they may be visiting patients that are in the hospital and be at a considerable distance from the doctor's office. Some doctors have more than one office to see patients and maintain different files at the different offices. Sometimes refill requests are received as phone calls where the doctor is not necessarily near the patient records or even have connection to the Internet.

The need to secure and access patient records is not limited to doctors or writing prescriptions. There are other cases where a person may need to securely store and have access to patient data. A large company, a nursing home, a school or even a summer camp may have a nurse (or some other trusted person) that holds patient data. This nurse or other trusted person would consult with the caregivers in the case of an emergency. Even though the nurse (or other trusted person) has no authority for writing prescriptions, there may still be a legitimate need for a person to securely store and maintain the patient records of another person. In this case it would also be extremely advantageous if the records were portable and could easily be displayed on nearly any personal computer.

Electronic checking of the patient records at the time that the prescription is written is needed to warn the doctor about possible adverse reactions to current medication or allergic reactions based on patient history. Relevant lab results should also be available at the time that the prescription is written. Insurance coverage information is needed at the time that the prescription is written so formulary decisions can be considered and so that only drugs that are compatible with the patient's insurance coverage are prescribed. Making formulary decisions at the time that the prescription is written reduces calls from pharmacies requesting a formulary change after the prescription has been written.

The patient's data may be partially stored in one memory device while more of the patient's data may be stored in another memory device. The electronic checking of patient records should have the ability of interfacing with other electronic medical record (EMR) systems.

It is very desirable to access patient records with the same software used to write prescriptions. This arrangement facilitates the checking of a prescription as it is written and facilitates updating the patient record after the prescription is written and eliminates the need for the user to learn multiple entry formats. In the same manner it is very desirable to receive refill requests from pharmacies with the same software that accesses patient records. The refill request can be reviewed in light of the patient history, informed drug choices can be made, and mistakes avoided.

There are several methods for storing patient records: 1) Patient records may not even be kept or maintained by the doctor and the doctor may rely solely on memory. Without patient records it is difficult to see trends and it is difficult to judge the effectiveness of past treatments. Dose adjustments need access to previous dose information. 2) Patient records are usually kept on a paper. The storing of patient records on paper has several shortcomings. Paper methods of writing prescriptions are error prone and depend on the pharmacist to discover errors in the prescription. Paper records are bulky, not as portable as technology permits and are usually limited to one location. Paper records are difficult to access quickly. Paper records are difficult to process, sort, or scan. Paper records are not encrypted and can be read by anyone. Additionally, prescription entries must be made on the paper records. This process is time consuming. 3) Patient records may be kept on a local terminal. The storing of patient records on a local terminal has several shortcomings. Patient data is less secure, since the local terminal is often a target for thieves. A local terminal is unnecessarily bulky and not as portable as technology permits. 4) Patient records may be kept on a third party's server and accessed by a local terminal. Patient records may be stored on a third party's server where patient's data is not controlled by the doctor and may be hacked and copied without authorization from the doctor or patient. Ownership of the data is less clear. Doctor patient confidentiality might not be maintained.

There are several methods of writing prescriptions: 1) Doctors may write prescriptions from a pad of paper. This approach has several disadvantages. The prescription pads are easily stolen and are an attractive target for thieves because they provide an easy access to drugs. There is no automatic checking of the prescription for spelling, dose, patient's history of reactions, etc. A convenient record of the prescription may not be made. 2) Doctors may write prescriptions from a local terminal that runs prescription writing software. This approach has several disadvantages. The doctor is limited to a specific local terminal. Local terminals are unnecessarily bulky and not as portable as technology permits. Local terminals are often unattended and thus less secure. Local terminals are attractive targets for thieves. Writing prescriptions from a local terminal is less secure than writing prescriptions from a local terminal through a server, since the server can control the writing process. Data is more secure if located at the local terminal, and even more secure if located on a portable memory device that can be connected to a local terminal only when it is needed, since access to each device is more limited. Such a portable memory device is also known as a dongle. 3) Doctors may write prescriptions from a local terminal with the prescription software located on a server. Such approaches are often called web-based prescription writing approaches. The eRx software provided by National ePrescribing Patient Safety Initiative (NEPSI) is an example of a web-based prescription writing approach. Web-based prescription writing approaches have the advantage that any local terminal that is connected to the web may be used to generate a prescription so in a sense they are very portable. Web-based prescription writing approaches still have a need to conveniently access the patient records. If the patient records are stored on a third party server, then patient data is not controlled by the doctor and may be hacked and copied without authorization or knowledge of the doctor or patient. Ownership of patient data stored on a third party server is less clear. Doctor patient confidentiality is not maintained. Storing patient records on a large local terminal is not desirable since this method is not portable. Storing patient records on a smaller local terminal (such as a laptop computer) is not desirable since a laptop computer is heavier and bulkier than necessary, hard to hide and a valuable tempting target for thieves.

There are several methods of requesting a prescription refill: 1) Pharmacies may call a doctor to request a prescription refill. This approach has the disadvantages that the doctor may not be at the office where the patient records are normally kept, and the call may interrupt the doctor. 2) Pharmacies may call a doctor's office to request a prescription refill; however this approach has several shortcomings. The doctor may not be at the office and so now the office must call the doctor. The office calling the doctor creates the same problems as if the pharmacy called the doctor. 3) Pharmacies may electronically send a doctor a request for a prescription refill. This approach has the advantage that it is convenient because the doctor is not interrupted and can answer the request at a more convenient time. To be effective, the doctor must have access to the patient records so an informed refill decision can be quickly made. The problem is again a need to store the patient records in a secure, accessible and portable manner.

A solution is needed where prescriptions may be written and refill requests may be responded to electronically in a way that is informed by easy access to the patient records, by access to insurance information and where the prescription is automatically checked for drug interactions and automatically compared to the patient's history for known drug reactions. Insurance coverage information should also be available at the time that the prescription is written so formulary decisions can be made at the time that the prescription is written. In addition, prescriptions should be electronically checked for dosage errors and misspelled words. This method of writing prescriptions, answering refill requests, and accessing patient records should be both portable and secure. In addition the solution should be able to update and maintain current patient records.

3. Objects and Advantages

Accordingly, it is an object of the present invention to provide a method of storing patient history that is secure and highly portable.

It is another object of this invention to provide a method of writing a prescription that is very secure and highly portable where the patient history may be easily accessed at the time that the prescription is written.

It is a further object of this invention to provide a method of responding to a prescription refill request that is secure and highly portable where the patient history, drug interaction information and patient insurance information may be easily accessed at the time that the prescription is written so formulary decisions are made at the time that the prescription is written thereby reducing later calls from pharmacies.

It is a still further object of this invention to provide a method of updating the patient records where the patient records are secure and highly portable and the method of updating the patient records may be done on almost any computer.

These and other objects of the present invention will become more apparent to those skilled in the art as the description of the present invention proceeds.

### SUMMARY

The present invention relates to electronic medical record storage and electronic writing of prescriptions. The patient records and controlling software are stored on a portable memory device which contains a cellular modem or a cellular phone connection such as a Bluetooth connection. The portable memory device connects to almost any computer (or local terminal) through a Universal Serial Bus (USB) connection. Other types of connections such as wireless are also possible. Once the portable memory device is attached to the local terminal, the local terminal processes the controlling software stored on the portable memory device. The controlling software is designed to initiate automatically. The cellular modem or cell phone connection provides an alternative wireless connection to the Internet in cases where the local terminal does not have a high speed Internet connection or a wireless internet connection is not available.

User authentication must be made before the patient data may be accessed, and before prescriptions may be written or refill requests answered. A remote server controls access to the portable memory device and permits or blocks operation of the software. If the portable memory device is lost or stolen or if access is attempted by the wrong person, the server will prevent access to patient data, stop prescriptions from being written, and prevent refill requests from being answered. Patient history, drug interaction information, and formulary information are available at the time that a prescription is written or a refill request answered.

### DRAWINGS

FIG. 1 is a schematic drawing of the preferred embodiment of the Pharmatrac system including its relation to the doctor, patient, pharmacies, and sources of patient and drug information.

FIG. 2 is a detailed schematic drawing of the preferred embodiment of the Pharmatrac dongle, the local terminal, and the Pharmatrac server shown in FIG. 1.

FIG. 3 is a schematic drawing of the second embodiment of the Pharmatrac system including its relation to the doctor, patient, pharmacies, and sources of patient and drug information.

FIG. 4 is a detailed schematic drawing of the second embodiment of the Pharmatrac dongle, the cell phone, the local terminal, and the Pharmatrac server shown in FIG. 3.

### DETAILED DESCRIPTION

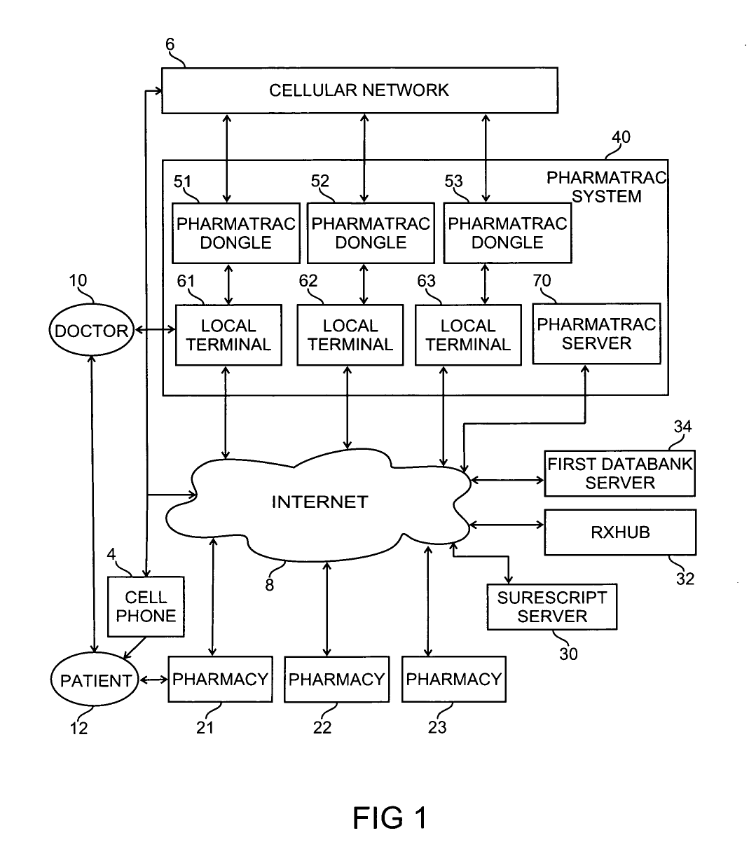

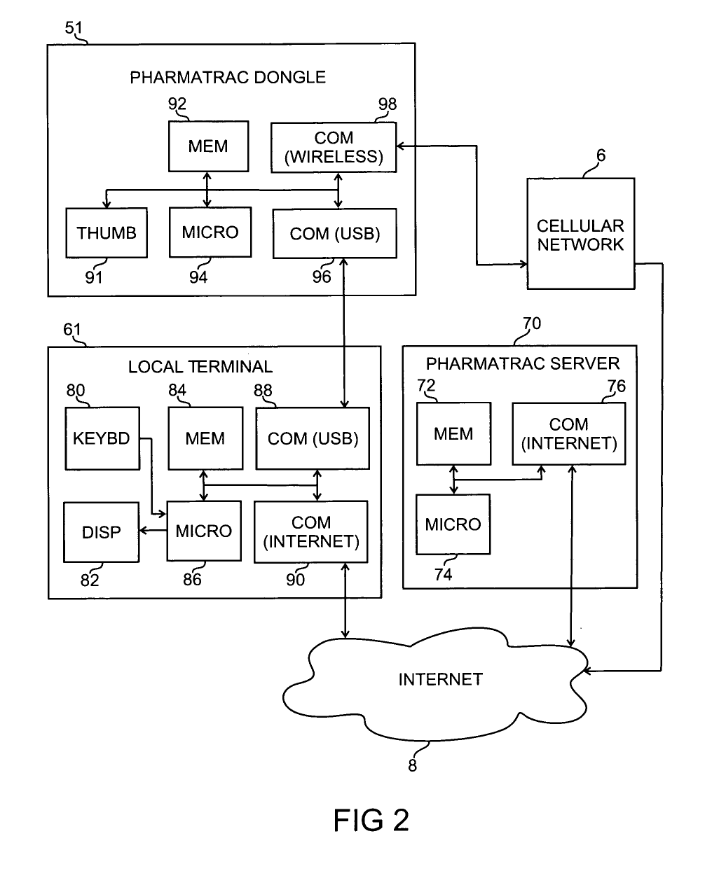

### FIGS. 1 and 2—Preferred Embodiment

FIG. 1 presents a medical record storage system and prescription writing and delivery system incorporating the preferred embodiment present invention. A Pharmatrac system 40 includes a Pharmatrac server 70 which is connected to a communications network such as Internet 8, and local terminals 61, 62, and 63 and Pharmatrac dongles 51, 52 and 53. Pharmatrac server 70 is connected to Internet 8. Each of local terminals 61, 62, and 63 may have connection to Internet 8. Each of Pharmatrac dongles 51, 52, and 53 may have connection to corresponding local terminals 61, 62, and 63. Each of Pharmatrac dongles 51, 52, and 53 may have connection to a cellular network 6. Pharmatrac dongles 52 and 53 are each functionally the same as Pharmatrac dongle 51.

Cellular network 6 is connected to Internet 8. Internet 8 is connected to a First DataBank server 34, an RxHub 32, a Surescript server 30, and pharmacies 21, 22, and 23. Surescript server 30 is connected to pharmacies 21, 22, and 23 via Internet 8. A prescriber such as doctor 10 interacts with local terminal 61 (or 62 or 63) and a patient 12. Patient 12 interacts with pharmacy 21 (or 22 or 23). First DataBank server 34 provides periodic drug lists and drug interaction information through Internet 8 to Pharmatrac server 70. RxHub 32 is a server that provides insurance coverage information (which is used to make formulary decisions as the prescription is written) through Internet 8. Surescript server 30 provides a service of sending prescription information and doctor identity authentication to Pharmacies 21, 22, and 23.

Three Pharmatrac dongles 51, 52, and 53, three local terminals 61, 62, and 63, and three pharmacies 21, 22, and 23 are shown in FIG. 1. Three of each are shown for explanation purposes only. Any number of each is possible. A Pharmatrac system 40 needs at least one Pharmatrac dongle 51, and at least one local terminal 61, and will communicate with at least one pharmacy 21. An actual Pharmatrac system 40 will have much more than three Pharmatrac dongles 51, 52, and 53, more than three local terminals 61, 62, and 63, and can communicate with more than three pharmacies 21, 22, and 23.

A more detailed view of the components of the Pharmatrac system 40 is presented in FIG. 2. Pharmatrac dongle 51 is comprised of a memory (mem) 92, a microprocessor (micro) 94, a universal serial bus connection (com(USB)) 96, a data entry device for a thumb or fingerprint (thumb) 91, and a cellular modem (com(wireless)) 98, all of which are connected together. A GSM type cellular modem may be used for com(wireless) 98, or other types of cellular modems and protocols such as CDMA, UMTS, W-CDMA, HSPA and HSUPA may also be used.

Local terminal 61 is comprised of a keyboard or a mouse (keybd) 80, a display device (disp) 82, a microprocessor (micro) 86, a memory (mem) 84, a universal serial bus connection (com(USB)) 88, and an Internet connection (com(Internet)) 90. Keybd 80 is connected to micro 86. Disp 82 is connected to micro 86. Micro 86, mem 84, universal serial bus connection (com(USB)) 88, and Internet connection (com(Internet)) 90 are all connected together.

Pharmatrac server 70 is comprised of a memory (mem) 72, a microprocessor (micro) 74, and an Internet connection (com(Internet)) 76. Mem 72, micro 74, and com(Internet) 76 are all connected together.

Com(USB) 96 of Pharmatrac dongle 51 is connected to com(USB) 88 of local terminal 61. Com(wireless) 98 of Pharmatrac dongle 51 is wirelessly connected to cellular network 6. Com(Internet) 76 of Pharmatrac server 70 is connected to Internet 8. Com(Internet) 90 of local terminal 61 is connected to Internet 8.

The operation of Pharmatrac system 40 is controlled by Pharmatrac server software located in mem 72 of Pharmatrac server 70 and by Pharmatrac dongle software located in mem 92 of Pharmatrac dongles 51, 52, and 53.

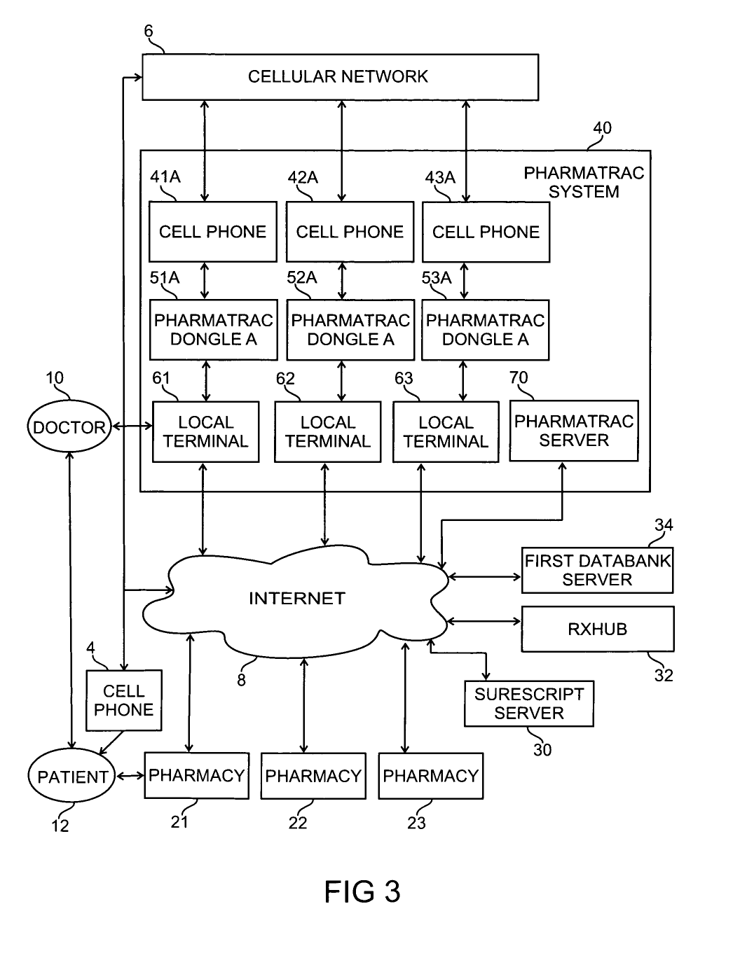

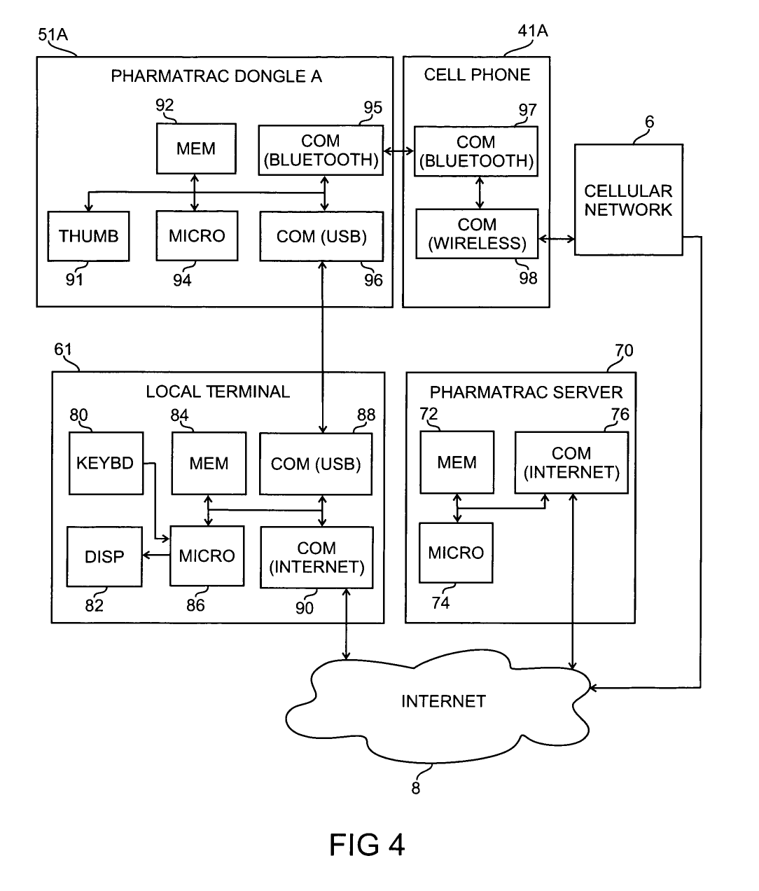

### FIGS. 3 and 4—Second Embodiment

A second embodiment of Pharmatrac system 40 is presented in FIGS. 3 and 4. The second embodiment differs from the preferred embodiment in that a Pharmatrac dongle A 51A is wirelessly connected to a cell phone 41A and cell phone 41A is wirelessly connected to cellular network 6. Similarly, a Pharmatrac dongle A 52A is wirelessly connected to a cell phone 42A and cell phone 42A is wirelessly connected to cellular network 6. A Pharmatrac dongle A 53A is wirelessly connected to a cell phone 43A and cell phone 43A is wirelessly connected to cellular network 6. Pharmatrac dongle A 51A consists of mem 92, micro 94, com(USB) 96, a com(Bluetooth) 95, and a data entry device for a thumb or fingerprint (thumb) 91, all connected together. Cell Phone 41A consists of a com(Bluetooth) 97 connected to com(wireless) 98. Com(Bluetooth) 95 of Pharmatrac dongle A 51A wirelessly connects to com(Bluetooth) 97 of cell phone 41A. Com(wireless) 98 connects to cellular network 6. Pharmatrac dongle A 51A and cell phone 41A of the second embodiment together function in the same way as Pharmatrac dongle 51 of the preferred embodiment.

### Detailed Operation Description

### FIG. 1 and 2—Preferred Embodiment

### Initial Software Installation

When Pharmatrac dongle 51 is connected to local terminal 61, Pharmatrac dongle software that is stored in mem 92 is processed by micro 86 of local terminal 61 according to the U3 software specification. USB flash drives adhering to the U3 specifications are able to store applications that can be run directly on a Microsoft compatible operating system. This means that an application adhering to the U3 software specification may be run without first being installed on the computer.

Other methods of initiating the Pharmatrac dongle software are also possible. For example another way of initiating the Pharmatrac dongle software is described in international patent application no. PCT/FR2006/000023.

The Pharmatrac dongle software processed by micro 86 controls the display of patient information on local terminal 61, the entering of patient data, which is stored on Pharmatrac dongle 51, the writing of prescriptions, and communication with Pharmatrac server 70.

### Optional Biometric Security Control of Prescription Writing and Patient Data

Disp 82 of local terminal 61 displays a prompt for doctor 10 to enter a name and password. Next, disp 82 of local terminal 61 instructs doctor 10 to provide biometric verification in the form of a thumb or fingerprint. The thumb or finger of doctor 10 is placed on thumb 91 of Pharmatrac dongle 51. Thumb 91 receives thumb or fingerprint information and sends this information to micro 86 of local terminal 61. Pharmatrac dongle software running on micro 86 of local terminal 61 does not allow access to patient records, prescription writing or answering refill requests if the thumb or fingerprint information does not match thumb or fingerprint information previously collected from doctor 10. If the information matches, then the Pharmatrac dongle software continues to execute.

### Pharmatrac Server Control of the Pharmatrac Dongle Software

Pharmatrac dongle software processed by micro 86 of local terminal 61 controls access to and decryption of patient information stored on mem 92. Pharmatrac dongle software processed by micro 86 also controls the execution of prescription writing software and prescription refill answering software. Pharmatrac system 40 provides two different options for controlling Pharmatrac dongle software. If the first option is selected, then Pharmatrac dongle 51 is disabled from writing prescriptions or accessing patient records until micro 86 receives a dongle enable command from Pharmatrac server 70. If the second option is selected, then Pharmatrac dongle 51 is enabled until micro 86 receives a dongle disable command from Pharmatrac server 70.

Pharmatrac dongle software processed by micro 86 is evidence that Pharmatrac dongle 51 is connected to local terminal 61. Micro 86 sends a portable memory device connected signal through Internet 8 to Pharmatrac server 70. The Pharmatrac dongle connected signal includes information that uniquely identifies it as either being from doctor 10, or from Pharmatrac dongle 51, or both. If the first option has been selected, then Pharmatrac dongle software processed by micro 86 will not continue other operations until it is enabled by Pharmatrac server 70. Pharmatrac server 70 selectively sends a dongle enable command to micro 86 through Internet 8.

If the second option has been selected, then Pharmatrac dongle software processed by micro 86 continues until it is disabled by Pharmatrac server 70. Pharmatrac server 70 selectively sends a dongle disable command to micro 86 through Internet 8.

When Pharmatrac dongle software has halted, any attempt to access patient records, to write a prescription, or to answer a prescription refill request is blocked since all of these actions depend on the processing of Pharmatrac dongle software by micro 86.

Before a prescription is written, Pharmatrac server 70 contacts First DataBank server 34 through Internet 8. First DataBank server 34 sends Pharmatrac server 70 an updated list of drugs and known drug interactions. Pharmatrac server 70 is periodically updated in this manner. Pharmatrac server 70 updates each of Pharmatrac dongles 51, 52, and 53.

There are two possible paths that update information may be sent from Pharmatrac server 70 to Pharmatrac dongle 51. In the first path, update information is sent from Pharmatrac server 70 to Internet 8, to local terminal 61, and then to Pharmatrac dongle 51.

In the second path, update information is sent from Pharmatrac server 70 to Internet 8, to cellular network 6, to com(wireless) 98 of Pharmatrac dongle 51. Regardless of the path taken, the update information is stored in mem 92 of Pharmatrac dongle 51.

### Writing a Prescription

Since doctor 10 is identified and authenticated and Pharmatrac dongle 51 is enabled, doctor 10 may now access the patient records stored on mem 92 of Pharmatrac dongle 51. Doctor 10 consults with patient 12 and accesses patient records that are stored on mem 92 of Pharmatrac dongle 51. Patient data stored on mem 92 is sent to com(USB) 96 and then to com(USB) 88. The patient data is then sent to micro 86 where it is decrypted and then displayed on disp 82.

Pharmatrac dongle software processed by micro 86 sends a request for patient insurance information to Pharmatrac server 70 via Internet 8. Pharmatrac server 70 contacts RxHub 32 through Internet 8 and receives patient insurance information from RxHub 32 including which drugs are covered by the insurance. From the patient's insurance information, doctor 10 may formulary decisions at the time that the prescription is written, thereby reducing calls from pharmacy 21.

Pharmatrac server 70 sends the patient insurance information through Internet 8 to com(Internet) 90 of local terminal 61. Corn (Internet) 90 sends the information to micro 86 where it is displayed on disp 82.

Doctor 10 enters information on keybd 80 of local terminal 61. Pharmatrac dongle software is processed by micro 86 and controls the display of data, the generation of the prescription, and then selects one of three available paths for sending the prescription to Pharmacy 21.

In the first path, local terminal 61 sends the prescription information to Surescript server 30 through Internet 8. Surescript server 30 then sends the prescription information to Pharmacy 21 through Internet 8.

In the second path, the prescription information is sent from local terminal 61 to pharmacy 21 directly through Internet 8.

In the third path, prescription information is sent from the corn (USB) 88 of local terminal 61 to com (USB) 96 of Pharmatrac dongle 51. The information is then sent to corn (wireless) 98, to cellular network 6, to Internet 8, and then to pharmacy 21. Pharmacy 21 fills the prescription for patient 12.

Storing patient data on Pharmatrac dongle 51 protects the patient's data because the data stays local and is never stored on local terminal 61 or on Pharmatrac server 70. Doctor 10 is always in control of the patient's data. It is true that a small part of patient data passes from Pharmatrac dongle 51 to local terminal 61, to Internet 8, to Pharmatrac Server 70, and finally to RxHub 32. Patient data is secure because it is encrypted at all times in Pharmatrac system 40. In addition, the small encrypted part patient data is not stored on Pharmatrac server 70 and only passes through Pharmatrac server 70. Since the patient's data does not reside on Pharmatrac server 70 the patient data is not vulnerable to hacking from outside of Pharmatrac system 40.

Writing a Web-Based Prescription with Patient Records on a Dongle

Pharmatrac system 40 is compatible with web-based prescription writing systems. Pharmatrac dongle 51 contains prescription writing software and patient medical records. In a web-based prescription writing system, local terminal 61 is used for the display and entering of data. The software for controlling the writing of prescriptions is stored and executed remotely.

Doctor 10 still needs to access the patient's data in order to write an informed prescription. If Pharmatrac dongle 51 is used with web-based prescription writing software, the Pharmatrac dongle software processed by micro 86 detects this condition and still allows access to the patient records. In this way the patient records are still portable, secure and in the control of doctor 10.

### Refilling a Prescription

Pharmacy 21 contacts Pharmatrac server 70 and delivers a prescription refill request according to two possible methods. In the first method, pharmacy 21 contacts Pharmatrac server 70 through Internet 8. Pharmatrac server 70 knows if Pharmatrac dongle 51 is connected to local terminal 61. If the requested doctor's Pharmatrac dongle 51 is attached to local terminal 61 and is activated, then Pharmatrac server 70 relays the prescription refill request to local terminal 61 where it is received by com(Internet) 90, sent to micro 86 and then sent to disp 82. Pharmatrac server 70 notifies pharmacy 21 that the refill request has been delivered. If requested Pharmatrac dongle 51 is not attached to local terminal 61 then Pharmatrac server 70 holds the request until Pharmatrac dongle 51 is attached to a local terminal 61. Pharmatrac server 70 notifies pharmacy 21 through Internet 8 that the refill request is being held until Pharmatrac dongle 51 is connected to local terminal 61. The refill request answer is sent from micro 86 to com(Internet) 90 to Internet 8 to Pharmacy 21.

In the second method, pharmacy 21 contacts Pharmatrac dongle 51 though Internet 8 and cellular network 6. Pharmatrac dongle 51 receives power only if it is connected to local terminal 61. If Pharmatrac dongle 51 is connected to local terminal 61, then corn (wireless) 98 may receive prescription refill requests from cellular network 6. The request is sent from com(wireless), 98 to com(USB) 96, to com(USB) 88 to micro 86, and then displayed on disp 82 for doctor 10. The refill request answer is sent from micro 86 to com(USB) 88 to com(USB) 96 to com(wireless) 98 to cellular network 6 to Internet 8 to pharmacy 21.

The first method is the preferred communication method since in the first method, the Pharmatrac server 70 is always available to receive the refill request from pharmacy 21. Furthermore since Pharmatrac server software running on micro 74 of Pharmatrac server 70 knows the status of each Pharmatrac dongle 51, 52, and 53, Pharmatrac server 70 is able to send the status information of Pharmatrac dongle 51 to pharmacy 21. The second communication method relies on the doctor's Pharmatrac dongle 51 being connected to local terminal 61 which may not be the case.

### Updating Prescription Writing Software

There are two methods for updating the Pharmatrac dongle software stored in mem 92 of Pharmatrac dongle 51. In the first method, updated Pharmatrac dongle software is sent from mem 72 of Pharmatrac server 70 to com(Internet) 76 of Pharmatrac server 70. The Pharmatrac dongle software in then sent to Internet 8 onto cellular network 6 and then to com(wireless) 98 of Pharmatrac dongle 51. The software is then sent from com(wireless) 98 to mem 92.

In the second method, Pharmatrac server 70 may send the software update to local terminal 61 through Internet 8. Local terminal 61 sends the Pharmatrac dongle software update to Pharmatrac dongle 51 and Pharmatrac dongle 51 stores the Pharmatrac dongle software update in mem 92.

Sending Text Messages to Patients' Cellular Phone. (Doctor to Patient Communication) Doctor 10 may send to patient 12 a text message that conforms to the short message service (SMS) protocol. Doctor 10 enters or selects message on local terminal 61. Local terminal 61 sends the text message to com(USB) 96 of Pharmatrac dongle 51. The text message is then sent to com(wireless) 98 of Pharmatrac dongle 51 where it is sent to cellular network 6. Cellular network 6 sends the message to the patient's cellular phone 4.

The sending of text messages can be done automatically. For example if doctor 10 chooses to remind patient 12 every 8 hours to take a medication, then Pharmatrac server 70 can be set to automatically send such a text message every 8 hours.

Sending Messages from the Pharmatrac Server to the Pharmatrac Dongle. (Pharmatrac to Doctor Communication)

Important information updates may come from Pharmatrac server 70 to be displayed on disp 82 of local terminal 61. This important information may take two paths. The first path is from Pharmatrac server 70 to Internet 8 to com(Internet) 90 to micro 86 and then to disp 82. The second path is from Pharmatrac server 70 to Internet 8 to cellular network 6 to com(wireless) 98 to com(USB) 96 to com(USB) 88 to micro 86 and then to disp 82.

### Backing Up Patient Data

Data stored on a memory device may become corrupted over time or the memory device may become lost or stolen. A backup of the patient's data may be needed to ensure that the patient's data is never lost. The preferred embodiment for backing up patient data is to use a second Pharmatrac dongle 52 to make a copy of a first Pharmatrac dongle 51. Doctor 10 designates first Pharmatrac dongle 51 containing the patient data and second Pharmatrac dongle 52 as being in the same group. Pharmatrac dongle software processed on micro 86 of local terminal 61 sends a request to transfer data signal to Pharmatrac server 70. The request to transfer data signal includes information that uniquely identifies it as either being from doctor 10, or from Pharmatrac dongle 51, or from both.

There are two methods of sending the request to transfer data signal to Pharmatrac server 70. In the first path, the request to transfer data signal is sent from local terminal 61 to Internet 8, to Pharmatrac server 70. In the second path, the request to transfer data signal is sent from micro 86 of local terminal 61, to com(USB) 88 to com(USB) 96, to com(wireless) 98 of Pharmatrac dongle 51, to cellular network 6, to Internet 8, and then to Pharmatrac server 70.

Pharmatrac server software running on micro 74 of Pharmatrac server 70 receives the request to transfer data signal and then selectively sends an enable data transfer signal to local terminal 61. There are two possible methods for sending the enable data transfer signal. In the first method, the signal is sent from Pharmatrac server 70, to Internet 8, to local terminal 61. In the second method, the signal is sent from Pharmatrac server 70, to Internet 8, to cellular network 6, to com(wireless) 98, to com(USB) 96, to com(USB) 88, to micro 86 of local terminal 61.

Pharmatrac dongle 52 may be connected to local terminal 62 (a different local terminal than Pharmatrac dongle 51 is connected to) or local terminal 61 (the same local terminal Pharmatrac dongle 51 is connected to). If Pharmatrac dongle 52 is connected to local terminal 62 then Pharmatrac dongle software controlled by micro 86 of local terminal 61 receives data from Pharmatrac dongle 51 and sends this data to Internet 8, and to local terminal 62. Pharmatrac dongle software processed on micro 86 of local terminal 62, then sends the data to Pharmatrac dongle 52.

If Pharmatrac dongle 52 is connected to local terminal 61 then Pharmatrac dongle software controlled by micro 86 of local terminal 61 receives data from Pharmatrac dongle 51 and sends this data to Pharmatrac dongle 52. Other methods of backing up the patient data are supported by Pharmatrac system 40, but these back up methods are not preferred.

In some cases doctor 10 may designate that two Pharmatrac dongles 51 and 52 as being in the same medical group and so may need to share patient data. The procedure for sharing patient data between two Pharmatrac dongles 51 and 52 that are in the same medical group uses the same procedure for backing up patient data on two Pharmatrac dongles 51 and 52. Patient data from Pharmatrac dongle 51 is first copied to Pharmatrac dongle 52. The procedure is then repeated with patient data from Pharmatrac dongle 52 copied to Pharmatrac dongle 51.

### Embodiment 2—FIGS. 3 and 4

In a second embodiment, Pharmatrac dongle A 51A and cell phone 41A together provide the same function as Pharmatrac dongle 51 of the preferred embodiment.

In the second embodiment, the software checks for a connection from com(Internet) 90 to Internet 8. This is the preferred connection if available, and communication from Pharmatrac dongle A 51A to Internet 8 will be through this path.

If a connection from com(Internet) 90 to Internet 8 is not available, then com(Bluetooth), 95 of Pharmatrac dongle 51A will establish a connection to com(Bluetooth) 97 of cell phone 41A. Com(Bluetooth) 97 will communicate with com(wireless) 98 and com(wireless) 98 will contact cellular network 6. Cellular network 6 will contact Internet 8. The first path is lower cost with a higher bandwidth and so is preferred over the second path.

### Conclusion Ramifications and Scope

Those skilled in the art will now appreciate that an improved method for writing prescriptions and storing patient history which is portable and secure has been devised. Storing patient records on a memory device eliminates the need of storing data on a server where the patient data may be illegally hacked and stolen. Controlling access to patient data from an external server improves the security of the data and maintains the doctor and patient confidentiality relationship.

Integrating the patient records with the method of writing prescriptions allows the doctor to make more informed prescription decisions for the patient. This is true for both prescriptions written by the doctor and refill requests from the pharmacy. Errors are greatly reduced and formulary information can be included at the time that the prescription is written.

While the present invention has been described with respect to a preferred embodiment thereof, such description is for illustrative purposes only, and is not to be construed as limiting the scope of the invention. Various modifications and changes may be made to the described embodiment by those skilled in the art without departing from the true spirit and scope of the invention as defined by the appended claims.

I claim:

1. A method for controlling access to medical records comprising:
a. providing a portable memory device which is able to store controlling software and said medical records,
b. providing a display device which is operationally connected to a microprocessor which will display said medical records,
c. providing said microprocessor which is operationally connected to said portable memory device by a universal serial bus connection which will,
1) process said controlling software,
2) selectively control display of said medical records,
3) detect when said portable memory device is operationally connected to said microprocessor,
4) send a unique portable memory device connected signal to a communications network,
5) receive a dongle control signal from said communications network,
d. providing said communications network operationally connected to said microprocessor which will,
1) receive said unique portable memory device connected signal from said microprocessor,
2) send said unique portable memory device connected signal to a server,
3) receive said dongle control signal from said server,
4) send said dongle control signal to said microprocessor,
e. providing said server operationally connected to said communications network which will,
1) receive said unique portable memory device connected signal from said communications network,
2) selectively send said dongle control signal to said communications network,
whereby access to said medical records is controlled by said server.

2. The method of claim 1 wherein,
a. said portable memory device is able to store reference fingerprint data and will,
1) send said reference fingerprint data to said microprocessor,
2) provide a fingerprint data entry device which will,
i) receive fingerprint data from a finger,
ii) send said fingerprint data to said microprocessor,
b. said microprocessor will,
1) receive said fingerprint data from said fingerprint data entry device,
2) receive said reference fingerprint data from said portable memory device,
3) compare said fingerprint data to said reference fingerprint data and produce a result,
4) selectively process said controlling software based on said result.

3. A method for controlling access to medical records comprising:
a. providing a portable memory device which is able to store controlling software and said medical records,
1) send a unique portable memory device connected signal to a cellular modem,
2) send a dongle control signal to a microprocessor,
b. providing a display device which is operationally connected to said microprocessor which will display said medical records,
c. providing said microprocessor which is operationally connected to said portable memory device by a universal serial bus connection which will,
1) process said controlling software,
2) selectively control display of said medical records,
3) detect when said portable memory device is operationally connected to said microprocessor,
4) send said unique portable memory device connected signal to said portable memory device,
5) receive said dongle control signal from said portable memory device,
d. providing said cellular modem operationally connected to said portable memory device which will,
1) receive said unique portable memory device connected signal from said portable memory device,
2) send said unique portable memory device connected signal to a cellular network,
3) receive said dongle control signal from said cellular network,
4) send said dongle control signal to said portable memory device,
e. providing said cellular network operationally connected to said cellular modem and operationally connected to a communications network which will,
1) receive said unique portable memory device connected signal from said cellular modem,
2) send said unique portable memory device connected signal to said communications network,
3) receive said dongle control signal from said communications network,
4) send said dongle control signal to said cellular modem,
f. providing said communications network operationally connected to said cellular network and operationally connected to a server which will,
1) receive said unique portable memory device connected signal from said cellular network,
2) send said unique portable memory device connected signal to said server,
3) receive said dongle control signal from said server,
4) send said dongle control signal to said cellular network,
g. providing said server operationally connected to said communications network which will,
1) receive said unique portable memory device connected signal from said communications network,
2) selectively send said dongle control signal to said communications network, whereby access to said medical records is controlled by said server.

4. The method of claim 3 wherein said cellular modem is attached to said portable memory device.

5. The method of claim 4 wherein,
a. said portable memory device is able to store reference fingerprint data and will,
1) send said reference fingerprint data to said microprocessor,
2) provide a fingerprint data entry device which will,
i) receive fingerprint data from a finger,
ii) send said fingerprint data to said microprocessor,
b. said microprocessor will,
1) receive said fingerprint data from said fingerprint data entry device,
2) receive said reference fingerprint data from said portable memory device,
3) compare said fingerprint data to said reference fingerprint data and produce a result,
4) selectively process said controlling software based on said result.

6. The method of claim 3 wherein,
a. a cellular phone is provided which contains said cellular modem,
b. said cellular modem is operationally connected to said portable memory device by a wireless connection.

7. The method of claim 6 wherein,
a. said wireless connection is a Bluetooth connection,
b. said portable memory device is able to store reference fingerprint data and will,
1) send said reference fingerprint data to said microprocessor,
2) provide a fingerprint data entry device which will,
i) receive fingerprint data from a finger,
ii) send said fingerprint data to said microprocessor,
c. said microprocessor will,
1) receive said fingerprint data from said fingerprint data entry device,
2) receive said reference fingerprint data from said portable memory device,
3) compare said fingerprint data to said reference fingerprint data and produce a result,
4) selectively process said controlling software based on said result.

8. A method for writing a prescription and sending said prescription to a pharmacy comprising:
a. providing a portable memory device which is able to store controlling software and medical records,
b. providing a display device which is able to display information,
c. providing a data entry device which is able to receive data from a prescriber,
d. providing a microprocessor which is operationally connected to said portable memory device by a universal serial bus connection, operationally connected to said display device, and operationally connected to said data entry device which will,
1) process said controlling software,
2) receive said medical records from said portable memory device,
3) control display of said medical records on said display device,
4) receive said data from said data entry device,
5) organize said data into said prescription,
6) send said prescription to a communications network,
e. providing said communication network operationally connected to said microprocessor and operationally connected to said pharmacy which will,
1) receive said prescription from said microprocessor,
2) send said prescription to a server,
3) receive said prescription from said server,
4) send said prescription to said pharmacy,
f. providing said server which is operationally connected to said communications network.

9. The method of claim 8 wherein,
a. said portable memory device is able to store reference fingerprint data and will,
1) send said reference fingerprint data to said microprocessor,
2) provide a fingerprint data entry device which will,
i) receive fingerprint data from a finger,
ii) send said fingerprint data to said microprocessor,
b. said microprocessor will,
1) receive said fingerprint data from said fingerprint data entry device,
2) receive said reference fingerprint data from said portable memory device,
3) compare said fingerprint data to said reference fingerprint data and produce a result,
4) selectively process said controlling software based on said result.

10. A method for writing a prescription and sending said prescription to a pharmacy comprising:
a. providing a portable memory device which is able to store controlling software and medical records,
b. providing a display device which is able to display information,
c. providing a data entry device which is able to receive data from a prescriber,
d. providing a microprocessor which is operationally connected to said portable memory device by a universal serial bus connection, operationally connected to said display device, and operationally connected to said data entry device which will,
1) process said controlling software,
2) receive said medical records from said portable memory device,
3) control display of said medical records on said display device,
4) receive said data from said data entry device,
5) organize said data into said prescription,
6) send said prescription to a communications network,
e. providing said communication network operationally connected to said microprocessor and operationally connected to said pharmacy which will,
1) receive said prescription from said microprocessor,
2) send said prescription to said pharmacy.

11. The method of claim 8 wherein,
a. said portable memory device is able to store reference fingerprint data and will,
1) send said reference fingerprint data to said microprocessor,
2) provide a fingerprint data entry device which will,
i) receive fingerprint data from a finger,
ii) send said fingerprint data to said microprocessor,
b. said microprocessor will,
1) receive said fingerprint data from said fingerprint data entry device,
2) receive said reference fingerprint data from said portable memory device,
3) compare said fingerprint data to said reference fingerprint data and produce a result,
4) selectively process said controlling software based on said result.

12. A method for writing a prescription and sending said prescription to a pharmacy comprising:
a. providing a portable memory device which is able to store controlling software and medical records which will,
1) receive said prescription from a microprocessor,
2) send said prescription to a cellular modem,
b. providing a display device which is able to display information,
c. providing a data entry device which is able to receive data from a prescriber,
d. providing said microprocessor which is operationally connected to said portable memory device by a universal serial bus connection, operationally connected to said display device, and operationally connected to said data entry device which will,
1) process said controlling software,
2) receive said medical records from said portable memory device,
3) control display of said medical records on said display device,
4) receive said data from said data entry device,
5) organize said data into said prescription,
6) send said prescription to said portable memory device,
e. providing a cellular modem operationally connected to said portable memory device which will,
1) receive said prescription from said portable memory device,
2) send said prescription to a cellular network,
f. providing said cellular network operationally connected to said cellular modem and operationally connected to a communications network which will,
1) receive said prescription from said cellular modem,
2) send said prescription to said communications network,
g. providing said communications network connected to said pharmacy which will,
1) receive said prescription from said cellular network,
2) send said prescription to a server,
3) receive said prescription from said server,
4) send said prescription to said pharmacy,
h. providing said server which is operationally connected to said communications network.

13. The method of claim 12 wherein said cellular modem is attached to said portable memory device.

14. The method of claim 13 wherein,
a. said portable memory device is able to store reference fingerprint data and will,
1) send said reference fingerprint data to said microprocessor,
2) provide a fingerprint data entry device which will,
i) receive fingerprint data from a finger,
ii) send said fingerprint data to said microprocessor,
b. said microprocessor will,
1) receive said fingerprint data from said fingerprint data entry device,
2) receive said reference fingerprint data from said portable memory device,
3) compare said fingerprint data to said reference fingerprint data and produce a result,
4) selectively process said controlling software based on said result.

15. The method of claim 12 wherein,
a. a cellular phone is provided which contains said cellular modem,
b. said cellular modem is operationally connected to said portable memory device by a wireless connection.

16. The method of claim 15 wherein,
a. said wireless connection is a Bluetooth connection,
b. said portable memory device is able to store reference fingerprint data and will,
1) send said reference fingerprint data to said microprocessor,
2) provide a fingerprint data entry device which will,
i) receive fingerprint data from a finger,
ii) send said fingerprint data to said microprocessor,
c. said microprocessor will,
1) receive said fingerprint data from said fingerprint data entry device,
2) receive said reference fingerprint data from said portable memory device,
3) compare said fingerprint data to said reference fingerprint data and produce a result,
4) selectively process said controlling software based on said result.

17. A method for writing a prescription and sending said prescription to a pharmacy comprising:
a. providing a portable memory device which is able to store controlling software and medical records,
1) receive said prescription from a microprocessor,
2) send said prescription to a cellular modem,
b. providing a display device which is able to display information,
c. providing a data entry device which is able to receive data from a prescriber,
d. providing said microprocessor which is operationally connected to said portable memory device by a universal serial bus connection, operationally connected to said display device and operationally connected to said data entry device which will,
1) process said controlling software,
2) receive said medical records from said portable memory device,
3) control display of said medical records on said display device,
4) receive said data from said data entry device,
5) organize said data into said prescription,
6) send said prescription to said portable memory device,
e. providing a cellular modem operationally connected to said portable memory device which will,
1) receive said prescription from said portable memory device,
2) send said prescription to a cellular network,
f. providing said cellular network operationally connected to said cellular modem and operationally connected to a communications network which will,
1) receive said prescription from said cellular modem,
2) send said prescription to said communications network,
g. providing said communications network connected to said pharmacy which will,
1) receive said prescription from said cellular network,
2) send said prescription to said pharmacy.

18. The method of claim 17 wherein said cellular modem is attached to said portable memory device.

19. The method of claim 18 wherein,
a. said portable memory device is able to store reference fingerprint data and will,
1) send said reference fingerprint data to said microprocessor,
2) provide a fingerprint data entry device which will,
i) receive fingerprint data from a finger,
ii) send said fingerprint data to said microprocessor,
b. said microprocessor will,
1) receive said fingerprint data from said fingerprint data entry device,
2) receive said reference fingerprint data from said portable memory device,
3) compare said fingerprint data to said reference fingerprint data and produce a result,
4) selectively process said controlling software based on said result.

20. The method of claim 17 wherein,
a. a cellular phone is provided which contains said cellular modem,
b. said cellular modem is operationally connected to said portable memory device by a wireless connection.

21. The method of claim 20 wherein,
a. said wireless connection is a Bluetooth connection,
b. said portable memory device is able to store reference fingerprint data and will,
1) send said reference fingerprint data to said microprocessor,
2) provide a fingerprint data entry device which will,
i) receive fingerprint data from a finger,
ii) send said fingerprint data to said microprocessor,
c. said microprocessor will,
1) receive said fingerprint data from said fingerprint data entry device,
2) receive said reference fingerprint data from said portable memory device,
3) compare said fingerprint data to said reference fingerprint data and produce a result,
4) selectively process said controlling software based on said result.

22. A method for receiving a prescription refill request from a pharmacy and sending a prescription refill answer to said pharmacy comprising:
a. providing a portable memory device which is able to store controlling software and medical records,
b. providing a display device which is able to display information,
c. providing a data entry device which is able to receive data from a prescriber,
d. providing a microprocessor which is operationally connected to said portable memory device by a universal serial bus connection, operationally connected to said display device and operationally connected to said data entry device which will,
1) process said controlling software,
2) receive said prescription refill request from a communications network,
3) receive said medical records from said portable memory device,
4) control display of said medical records on said display device,
5) receive said data from said data entry device,
6) organize said data into said prescription refill answer,
7) send said prescription refill answer to said communications network,
e. providing said communication network which is operationally connected to said microprocessor and operationally connected to said pharmacy which will,
1) receive said prescription refill request from said pharmacy,
2) send said prescription refill request to a server,
3) receive said prescription refill request from said server,
4) send said prescription refill request to said microprocessor,
5) receive said prescription refill answer from said microprocessor,
6) send said prescription refill answer to said pharmacy,
f. providing said server which is operationally connected to said communications network which will,
1) receive said prescription refill request from said communications network,
2) send said prescription refill request to said communications network.

23. The method of claim 22 wherein,
a. said portable memory device is able to store reference fingerprint data and will,
1) send said reference fingerprint data to said microprocessor,
2) provide a fingerprint data entry device which will,
i) receive fingerprint data from a finger,
ii) send said fingerprint data to said microprocessor,
b. said microprocessor will,
1) receive said fingerprint data from said fingerprint data entry device,
2) receive said reference fingerprint data from said portable memory device,
3) compare said fingerprint data to said reference fingerprint data and produce a result,
4) selectively process said controlling software based on said result.

24. A method for receiving a prescription refill request from a pharmacy and sending a prescription refill answer to said pharmacy comprising:
a. providing a portable memory device which is able to store controlling software, medical records, and which will,
1) receive said prescription refill request from a cellular network,
2) send said prescription refill request to a microprocessor,
3) receive said prescription refill answer from said microprocessor,
4) send said prescription refill answer to said cellular network,
b. providing a display device which is able to display information,
c. providing a data entry device which is able to receive data from a prescriber,
d. providing said microprocessor which is operationally connected to said portable memory device by a universal serial bus connection, operationally connected to said display device, and operationally connected to said data entry device which will,
1) process said controlling software,
2) receive said prescription refill request from said portable memory device,
3) receive said medical records from said portable memory device,
4) control display of said medical records on said display device,
5) receive said data from said data entry device,
6) organize said data into said prescription refill answer,
7) send said prescription refill answer to said portable memory device,
e. providing said communication network operationally connected to said microprocessor and to said cellular network which will,
1) receive said prescription refill request from said pharmacy,
2) send said prescription refill request to said cellular network,
3) receive said prescription refill answer from said cellular network,
4) send said prescription refill answer to said pharmacy,
f. providing said cellular network wirelessly connected to said cellular modem which will,
1) receive said prescription refill request from said communications network,
2) send said prescription refill request to said cellular modem,
3) receive said prescription refill answer from said cellular modem,
4) send said prescription refill answer to said communications network,
g. providing a cellular modem operationally connected to said portable memory device which will,
1) receive said prescription refill request from said cellular network,
2) send said prescription refill request to said portable memory device,
3) receive said prescription refill answer from said portable memory device,
4) send said prescription refill answer to said cellular network.

25. The method of claim 24 wherein said cellular modem is attached to said portable memory device.

26. The method of claim 25 wherein,
a. said portable memory device is able to store reference fingerprint data and will,
1) send said reference fingerprint data to said microprocessor,
2) provide a fingerprint data entry device which will,
i) receive fingerprint data from a finger,
ii) send said fingerprint data to said microprocessor,
b. said microprocessor will,
1) receive said fingerprint data from said fingerprint data entry device,
2) receive said reference fingerprint data from said portable memory device,
3) compare said fingerprint data to said reference fingerprint data and produce a result,
4) selectively process said controlling software based on said result.

27. The method of claim 24 wherein,
a. a cellular phone is provided which contains said cellular modem,
b. said cellular modem is operationally connected to said portable memory device by a wireless connection.

28. The method of claim 27 wherein,
a. said wireless connection is a Bluetooth connection,
b. said portable memory device is able to store reference fingerprint data and will,
1) send said reference fingerprint data to said microprocessor,
2) provide a fingerprint data entry device which will,
i) receive fingerprint data from a finger,
ii) send said fingerprint data to said microprocessor,
c. said microprocessor will,
1) receive said fingerprint data from said fingerprint data entry device,
2) receive said reference fingerprint data from said portable memory device,
3) compare said fingerprint data to said reference fingerprint data and produce a result,
4) selectively process said controlling software based on said result.

29. A method for updating prescription writing software which is stored on a portable memory device comprising:
a. providing said portable memory device which is able to store said prescription writing software,
b. providing a microprocessor operationally connected to said portable memory device by a universal serial bus connection which will,
1) process said prescription writing software,
2) receive a software update from a communications network,
3) send said software update to said portable memory device,
c. providing said communication network operationally connected to said microprocessor which will,
1) receive said software update from a server,
2) send said software update to said microprocessor,
d. providing said server operationally connected to said communication network which will send said software update to said communication network.

30. A method for updating prescription writing software which is stored on a portable memory device comprising:
a. providing said portable memory device which is able to store said software,
b. providing a microprocessor which is operationally connected to said portable memory device by a universal serial bus connection which will process said prescription writing software,
c. providing a cellular modem operationally connected to said portable memory device which will,
1) receive a software update from a cellular network,
2) send said software update to said portable memory device,
d. providing said cellular network operationally connected to said cellular modem which will,
1) receive said software update from a server,
2) send said software update to said cellular modem,
e. providing said server connected to said cellular network which will send said software update to said cellular network.

31. The method of claim 30 wherein said cellular modem is attached to said portable memory device.

32. The method of claim 30 wherein,
a. a cellular phone is provided which contains said cellular modem,
b. said cellular modem is operationally connected to said portable memory device by a wireless connection.

33. The method of claim 32 wherein said wireless connection is a Bluetooth connection.

34. A method for sending a text message to a second cellular phone comprising:
a. providing a display device operationally connected to a microprocessor which will display said text message,
b. providing a data entry device operationally connected to said microprocessor which will send data to said microprocessor,
c. providing said microprocessor which will,
1) process controlling software,
2) receive said data from said data entry device,
3) control display of said data,
4) organize said data into said text message,
5) send said text message to a portable memory device,
d. providing said portable memory device operationally connected to said microprocessor by a universal serial bus connection which is able to store said controlling software and will,
1) receive said text message,
2) send said text message to a first cellular modem,
e. providing said first cellular modem operationally connected to said portable memory device which will,
1) receive said text message,
2) send said text message to a cellular network,
f. providing said cellular network operationally connected to said first cellular modem and to said second cellular phone which will,
1) receive said text message from said first cellular modem,
2) send said text message to said second cellular phone.

35. The method of claim 34 wherein said first cellular modem is attached to said portable memory device.

36. The method of claim 34 wherein,
a. a cellular phone is provided which contains said cellular modem,
b. said cellular modem is operationally connected to said portable memory device by a wireless connection.

37. The method of claim 36 wherein said wireless connection is a Bluetooth connection.

38. A method of sending a message from a server to a display device comprising:
a. providing said server operationally connected to a communication network which will send said message to said communications network,
b. providing said communications network operationally connected to a cellular network which will,
1) receive said message from said server,
2) send said message to said cellular network,
c. providing said cellular network operationally connected to a cellular modem which
1) receive said message from said cellular network,
2) send said message to said cellular modem,
d. providing said cellular modem operationally connected to a portable memory device and wirelessly connected to said cellular network which will,
1) receive said message from cellular network,
2) send said message to said portable memory device,
e. providing said portable memory device operationally connected to a microprocessor by a universal serial bus connection which is able to store controlling software and will,
1) receive said message from said cellular modem,
2) send said message to said microprocessor,
f. providing said microprocessor operationally connected to said display device which will,
1) process said controlling software,
2) receive said message from said portable memory device,
3) send said message to said display device,
g. providing said display device which will,
1) receive said message from said microprocessor,
2) display said message.

39. The method of claim 38 wherein said cellular modem is attached to said portable memory device.

40. The method of claim 38 wherein,
a. a cellular phone is provided which contains said cellular modem,
b. said cellular modem is operationally connected to said portable memory device by a wireless connection.

41. The method of claim 40 wherein said wireless connection is a Bluetooth connection.

42. A method for copying medical records from a first portable memory device to a second portable memory device comprising:
a. providing said first portable memory device which stores first microprocessor controlling software and said medical records,
b. providing a second portable memory device which stores second microprocessor controlling software and will receive said medical records,
c. providing a first microprocessor which is operationally connected to said first portable memory device by a first universal serial bus connection which will,
1) process said first microprocessor controlling software,
2) send a unique request to transfer data signal to a communications network,
3) receive an enable data transfer signal from said communications network,
4) receive said medical records from said first portable memory device,
5) send said medical records to said communications network,
d. providing a second microprocessor which is operationally connected to said second portable memory device by a second universal serial bus connection which will,
1) process said second microprocessor controlling software,
2) receive said set of medical records from a communications network,
3) send said set of medical records to a second portable memory device,
e. providing said communications network which is operationally connected to said first microprocessor and operationally connected to said second microprocessor which will,
1) receive said unique request to transfer data signal from said first microprocessor,
2) send said unique request to transfer data signal to a server,
3) receive said enable data transfer signal from said server,
4) send said enable data transfer signal to said first microprocessor,
5) receive said medical records from said first microprocessor,
6) send said medical records to said second microprocessor,
f. providing said server which is operationally connected to said communications network which will,
1) receive said unique request to transfer data signal from said communications network,
2) selectively send said enable data transfer signal to said communications network, whereby transfer of said medical records from said first portable memory device to said second portable memory device is controlled by said server.

43. A method for copying medical records from a first portable memory device to a second portable memory device comprising:
a. providing said first portable memory device which stores controlling software and said medical records,
b. providing said second portable memory device which will receive said medical records,
c. providing a microprocessor which is operationally connected to said first portable memory device by a first universal serial bus connection and operationally connected to said second portable memory device by a second universal serial bus connection which will,
1) process said controlling software,
2) send a unique request to transfer data signal to a communications network,
3) receive an enable data transfer signal from said communications network,
4) receive said medical records from said first portable memory device,
5) send said medical records to said second portable memory device,
d. providing said communications network which is operationally connected to said microprocessor which will,
1) receive said unique request to transfer data signal from said microprocessor,
2) send said unique request to transfer data signal to a server,
3) receive said enable data transfer signal from said server,
4) send said enable data transfer signal to said microprocessor,
e. providing said server which is operationally connected to said communications network which will,
1) receive said unique request to transfer data signal from said communications network,
2) selectively send said enable data transfer signal to said communications network, whereby transfer of said medical records from said first portable memory device to said second portable memory device is controlled by said server.
